(19) United States
(12) Patent Application Publication
(10) Pub. No.: US 2005/0192791 A1
(43) Pub. Date: Sep. 1, 2005

(54) Method for emulating an integrated circuit and semiconductor chip for practicing the method

(76) Inventor: Albrecht Mayer, Deisenhofen (DE)

Correspondence Address: BAKER BOTTS L.L.P.;PATENT DEPARTMENT, 98 SAN JACINTO BLVD., SUITE 1500, AUSTIN, TX, 78701-4039, US

(21) Appl. No.: 11/058,144

(22) Filed: Feb. 15, 2005

(30) Foreign Application Priority Data
Feb. 20, 2004 (DE) 102004008499.8

(51) Int. Cl. G06F 9/455

(52) U.S. Cl. 703/28

(57) ABSTRACT

An emulation method and a semiconductor chip for emulating an integrated circuit, in particular a program-controlled device, by means of an emulation circuit, which is arranged on the same semiconductor chip as the integrated circuit, has a trace memory and is coupled to the integrated circuit to be emulated via an internal interface, said method having the following method steps of: emulating the integrated circuit using the emulation circuit, continually storing the emulation results obtained during the emulation in the trace memory until the trace memory is full; interrupting the emulation; reading out the emulation results from the trace memory; and continuing the emulation of the integrated circuit.

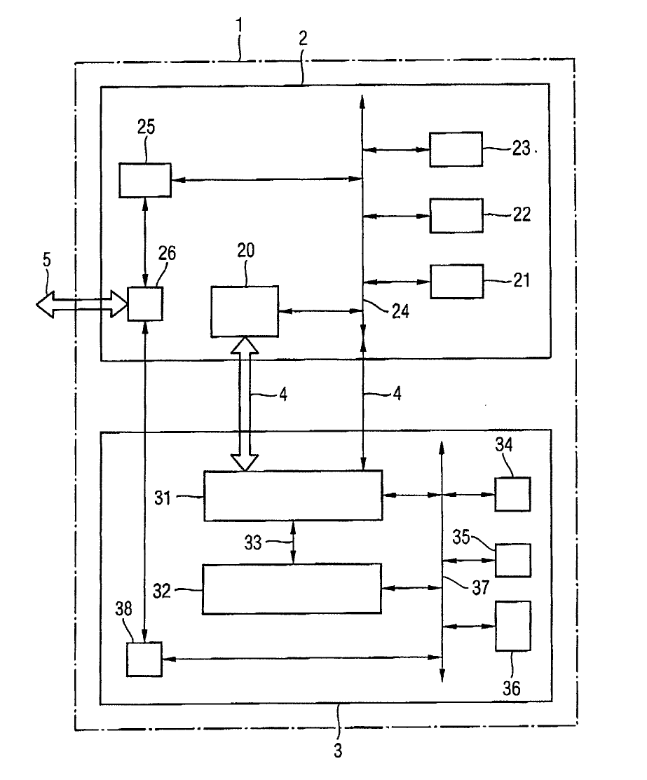

### PRIORITY

This application claims priority to German application number 10 2004 008499.8 filed Feb. 20, 2004.

### TECHNICAL FIELD OF THE INVENTION

The invention relates to a method for emulating an integrated circuit, in particular a program-controlled device, and also to a semiconductor chip having such an integrated circuit.

### BACKGROUND OF THE INVENTION

Integrated circuits of this type may contain, by way of example, a program-controlled device, for example a microprocessor, microcontroller, signal processor or the like. The design of such program-controlled devices has been widely known for many years in countless embodiments, with the result that it will not be discussed in any more detail below.

As the complexity of such integrated circuits increases and as the speed at which they are operated becomes ever higher, ever greater importance is attached to checking the proper operation of these integrated circuits. One known problem of program-controlled devices is that their proper operation can be checked only with great difficulty and a relatively large outlay, with the result that faults which occur in the program-controlled device often cannot be readily located and/or eliminated.

So-called emulators which can be used to monitor internal states and processes, for example register contents, memory contents, addresses, data and control signals which are transmitted via internal/external lines, etc., during normal operation of the integrated circuit and can also be used to change said states and processes in accordance with the desired configuration were developed for particularly complex integrated circuits. When emulating an integrated circuit, the latter is generally removed from the system that contains it and is replaced with a special circuit, this special circuit containing the integrated circuit to be tested itself or a special version of the integrated circuit, a so-called bond-out version, which has additional terminals for monitoring internal states or operations.

Another approach is to simulate systems. In simulation models, all internal states (buses, signals, register contents) can be monitored in a very detailed manner without increasing system costs. A further advantage of simulation is that it can also be carried out even before system components are available and that various system designs can be tried out in a cost-effective manner. A prerequisite for a system simulation is obviously the presence of models for all system components and an acceptable simulation speed of the overall model.

One problem with simulating modern integrated circuits is that the complexity of modern integrated circuits is increasing very much more quickly than the speed of existing simulation computers. The exact simulation of integrated circuits and of the corresponding overall systems requires the incorporation of models (which are as cyclically accurate as possible) of this integrated circuit and of the corresponding systems. However, in comparison with the complexity of the integrated circuits, these models are becoming increasingly slower and therefore no longer allow a sufficient depth of simulation, that is to say the length of time needed for a simulation in order to obtain sufficiently comprehensible results, for the integrated circuit and the corresponding system.

U.S. Pat. No. 5,748,875 and U.S. Pat. No. 6,202,044 B1 respectively describe apparatuses for simulating an integrated circuit. In those documents, so-called hardware adapters are provided for emulating or simulating an integrated circuit that may contain, for example, an FPGA circuit or a program-controlled device. A hardware adapter can be used to externally emulate the integrated circuit, it being possible to select a degree of detailing (which can be arbitrarily selected in this case) for monitoring the integrated circuit. In this case, the emulation is effected by applying input signals to the integrated circuit to be emulated and by applying a clock signal. The output signals which are thereby generated in the integrated circuit are read out and evaluated.

Placing the hardware adapter onto the integrated circuit to be emulated for the purpose of emulation has the fundamental drawback, however, that the integrated circuit to be emulated practically behaves like a “black box”. However, depending on the complexity, this black box that represents the integrated circuit contains a multiplicity of components, circuit parts and functional units and also more or less complex software. The contents of the black box mentioned and the individual states are unknown to an external observer, that is to say to the hardware adapter, and therefore cannot be derived from the emulation results either.

### SUMMARY OF EMBODIMENTS OF THE INVENTION

The present invention is thus based on the object of making it possible to emulate an integrated circuit in a manner which is as simple and reliable as possible.

According to an embodiment of the invention, there is provided:
a method and semiconductor chip for emulating an integrated circuit, in particular a program-controlled device, by means of an emulation circuit, which is arranged on the same semiconductor chip as the integrated circuit, has a trace memory and is coupled to the integrated circuit to be emulated via an internal interface, said method having the method steps of: emulating the integrated circuit using the emulation circuit, continually storing the emulation results—obtained during the emulation—in the trace memory until the trace memory is full; interrupting the emulation; reading out the emulation results from the trace memory; and continuing the emulation of the integrated circuit.
A semiconductor chip having an integrated circuit, in particular having a program-controlled device, having an integrated emulation circuit, which has a trace logic circuit for emulating the integrated circuit and also a trace memory for storing the emulation results which are ascertained during the emulation of the integrated circuit, having an internal interface for coupling the emulation circuit to the integrated circuit, and having an external interface, via which the integrated circuit and the emulation circuit can be supplied with a clock signal and via which the trace memory can be read.

According to the invention, the integrated circuit is equipped with an emulation circuit, which is integrated on the same semiconductor chip as the integrated circuit. On the one hand, the emulation circuit has a trace logic circuit, which is coupled to the integrated circuit via an internal interface and which can therefore be used to emulate the integrated circuit. The emulation circuit also has a trace memory, in which the emulation results can be stored. The emulation circuit thus makes it possible, in accordance with the programming and configuration of the integrated circuit, to monitor the internal program flow and all bus transactions within the integrated circuit over several thousand to a hundred thousand clock cycles. This primarily depends on the size of the trace memory. By virtue of the fact that it is thus possible to respectively read out individual states of the integrated circuit, the integrated circuit no longer behaves like a “black box” (mentioned initially) during emulation but rather like a “white box”. Specifically, by virtue of the fact that individual states of the integrated circuit are respectively obtained in a cyclically accurate manner when an input signal and a clock signal for the emulation are applied, specific and comprehensible conclusions regarding the integrated circuit itself, and thus any faults which are possibly present in the integrated circuit, can be drawn from said states. If the integrated circuit contains a program-controlled device, the software running on it, in particular, may also be monitored and faults may be analyzed.

After a predetermined time that depends on the memory size of the trace memory, the latter is full and must be read. A boundary condition when reading the trace memory is, then, that the state of the integrated circuit and of the trace logic circuit emulating this integrated circuit must not be changed in this phase. For this reason, according to the invention, the emulation is stopped as soon as the trace memory is full. Then, that is to say after the read operation, the trace memory can be read again via an external interface. After the trace memory has been read, the emulation is continued, for example in the last state before the emulation was interrupted or stopped.

The proposed method therefore has the requisite condition that the process for the overall system can be stopped at any desired points in time and can then be continued again. That is always the case for simulated systems but can also be achieved for systems which are emulated using FPGAs or hardware accelerators or hybrid systems which partially contain the real hardware components.

The method according to the invention and the arrangement according to the invention can be used to emulate this integrated circuit in a very elegant but nevertheless very reliable manner by virtue of the fact that it is possible to read out individual states of the integrated circuit. Conclusions regarding individual circuit elements, circuit parts, circuit modules and also program elements can thus be drawn from these states which have been read out.

The particular advantage of the method according to the invention is also that the integrated circuit can be emulated, and this circuit can thus be monitored, over an arbitrary period of time without having to accept data losses on account of the trace memory being read. Although stopping the emulation if the trace memory is full delays the entire system slightly, the user is thereby assured that the integrated circuit has been monitored and emulated in full and thus that all possible states of the integrated circuit have actually been ascertained.

Advantageous refinements and developments of the invention emerge from the subclaims and from the description with reference to the drawings.

In a very advantageous refinement of the method according to the invention, only those parts of the emulation circuit and/or of the integrated circuit which, from the point of view of the emulation, are not required, and are thus irrelevant, for the state of the emulation circuit and/or of the integrated circuit are used for reading out the emulation results from the trace memory. All other circuit elements and circuit parts are then advantageously in a mode in which their state does not change. This may be effected, for example, by operating these parts of the emulation circuit and/or of the integrated circuit without a clock.

Alternatively, an instantaneous state of the integrated circuit may also be read out, for example, by means of scan chains. This state is then read out from the trace memory. After the trace memory has been read, the state is written back to the integrated circuit again.

An occupancy signal that indicates that the trace memory is full or will shortly be full is advantageously output. The emulation of the integrated circuit is interrupted in response to this occupancy signal.

In a likewise very advantageous refinement of the invention, in order to set the desired configuration, the emulation circuit and the trace logic circuit contained therein are preprogrammed before the start of the emulation.

In an advantageous refinement of the method according to the invention, the system clock of the integrated circuit is set externally, that is to say from outside the semiconductor chip.

An alternative particularly advantageous method provides for all parts of the semiconductor chip, that is to say all parts of the integrated circuit and of the emulation circuit, which are not needed to read the trace memory to be put into a type of “sleep mode”. This can be realized, for example, by switching off the system clock for these modules. In this way, all states of these modules are virtually frozen.

In a very advantageous refinement of the method according to the invention, the integrated circuit and also the emulation circuit can additionally be modified during the read-out mode of the trace memory. In this case, for example, register contents, data contents of flip-flops and the like which belong to the same application as the emulated part of the integrated circuit can be specifically read or modified. It is thus possible to deliberately intervene in individual states of the integrated circuit during the emulation thereof. Additionally or alternatively, it is also possible to deliberately intervene in the configuration of the trace logic circuit 31 during the trace read-out mode.

The external interface of the semiconductor chip is advantageously in the form of a JTAG interface. The clock distribution in the integrated circuit is controlled and also changed via this JTAG interface. During read-out operation, the clock supply of the integrated circuit can be interrupted or virtually “frozen” via the JTAG interface. During this read-out operation, only the emulation circuit, more precisely the trace memory, is supplied with the system clock. This makes it possible to read the trace memory. After the trace memory has been read, a control signal is used to signal this, with the result that the integrated circuit is supplied with a system clock again. With the system clock switched on again, the emulation of the integrated circuit is continued again in the last state, for example the frozen state.

The semiconductor chip according to the invention advantageously has a control circuit, which supplies the integrated circuit and/or the emulation circuit with the system clock in a manner dependent on the configuration set.

In addition, the control circuit may also be designed to ascertain the occupancy of the trace memory and, in the event of a predetermined occupancy being exceeded, to initiate the operation of reading the trace memory. This is effected, for example, by interrupting the system clock for the integrated circuit and the trace logic circuit.

The emulation circuit advantageously has an output terminal, which is connected to an external interface and which can be used to signal to the outside whether and that the trace memory is full. Alternatively, it can also be signaled, in this way, that the trace memory will shortly be full, so that the corresponding measures for reading the trace memory can already be initiated before the latter is completely full.

In order to read the integrated circuit, the latter and/or the trace logic circuit has/have a scan chain. The scan chain can be used to read out individual states or else a plurality of states of the integrated circuit.

In a typical refinement, the integrated circuit to be emulated is in the form of a program-controlled device. Such a program-controlled device is, for example, a microprocessor or a microcontroller. The invention is particularly suited to integrated circuits which are in the form of program-controlled devices since experience has shown that the highest degree of complexity of the integrated circuit is present in this case and it is thus particularly difficult to emulate or simulate this integrated circuit.

### BRIEF DESCRIPTION OF THE DRAWING

The invention is explained in more detail below with reference to the single FIGURE of the drawing. In this case, the FIGURE shows a block diagram for illustrating a semiconductor chip according to the invention, which has an integrated circuit to be emulated and an emulation circuit.

### DETAILED DESCRIPTION OF EMBODIMENTS OF THE INVENTION

Reference symbol 1 is used in the figure to designate the semiconductor chip according to the invention. The semiconductor chip 1 has an integrated circuit 2 and an emulation circuit 3 which are integrated on the same semiconductor chip 1. The integrated circuit 2 and the emulation circuit 3 are internally coupled to one another via an internal bus 4, which forms an internal interface. Provision is also made of an external interface 5, which is used to externally connect the integrated circuit 2 and/or the emulation circuit 3. This interface need not necessarily be part of the integrated circuit 2. It may also be part of the emulation circuit 3. Alternatively, it is also conceivable for both circuits to respectively have their own interfaces.

In the present example embodiment, it shall be assumed that the integrated circuit 2 is in the form of a program-controlled device, in particular a microcontroller. The integrated circuit 2 has a CPU 20, peripheral units 21, 22, 23 such as, for example, a timer, one or more AD converters, a memory, a watch-dog, an oscillator, etc., a CPU 20 and an internal bus 24, which connects the peripheral units 21-23. In order to assist the in-circuit emulation, the external interface 5 is in the form of a JTAG interface and has, for this purpose, a JTAG module 26, via which the integrated circuit 2 and the emulation circuit 3 are connected to the external interface 5. The external interface 5 and the JTAG module 26 representing this external interface are connected to the internal bus 24 via a bus master 25, which forms the debug access port.

The emulation circuit 3 is used to emulate, that is to say to monitor and record the states of the integrated circuit 2. To this end, the emulation circuit 3 has a trace logic circuit 31 and a trace memory 32 which are coupled to one another via a bidirectional data line 33. The trace logic circuit 31 is also connected to the integrated circuit 2, in particular to the CPU 20 and the internal bus 24 in this case, via the internal interface 4. This internal interface 4 can be used, in a manner controlled by means of the trace logic circuit 31, to monitor states of the integrated circuit 2 and to store them in the trace memory 32 via data lines 33. Moreover, these states which are stored in the trace memory 32 can also be written back again, via the trace logic circuit 31, to the locations of the integrated circuit 2 which are intended for them.

The trace logic circuit may, for example, be in the form of an FPGA circuit or a PLD circuit, which can be programmed by means of the integrated circuit 2 or by means of the external interface in such a manner that the desired configuration of the trace logic circuit 31 can be set as required.

The emulation circuit 3 also has peripheral units 34, 35, for example a buffer memory, a timer, etc., and a control device 36 which are connected to an internal bus 37. The trace logic circuit 31 and the trace memory 32 are also connected to said internal bus 37. In the same way as the integrated circuit 2, the emulation circuit 3 also has a bus master 38, which is connected to the JTAG module 26 and thus to the external interface 5 and which therefore makes it possible for the internal bus 37 to be connected to the external interface 5.

The method according to the invention for emulating the integrated circuit 2 by means of the emulation circuit 3 shall be explained in more detail below with reference to the figure.

Before the start of the emulation, the elements of the trace logic circuit 31 are first of all preprogrammed. A normal reset at the start of the emulation thus does not change the configuration of the trace logic circuit.

In order to emulate the integrated circuit 2, a clock signal (not illustrated in the figure) must be applied to the integrated circuit and the emulation circuit 3. In order to ensure that the temporal sequence of the integrated circuit and that of the external system are synchronous, said clock is used, for example, in a so-called “direct drive mode”, that is to say without an interposed phase locked loop.

During the emulation of the integrated circuit 2, emulation results which give information about the individual states of the integrated circuit 2 are continuously transmitted in a clock-synchronous manner via the internal interface 4. This read-out operation is controlled by means of the trace logic circuit 31 or additionally or alternatively by means of the control device 36 as well. The trace logic circuit 31 uses data lines 33 to store these emulation results in areas of the trace memory 32 that are specifically intended for them. The emulation of the integrated circuit 2, the reading-out of the emulation results by the trace logic circuit 31 and the storage of the emulation results in the trace memory 32 are continued until the trace memory 32 is full or will shortly be full.

This occupancy of the trace memory 32 and thus the determination of those resources of the trace memory 32 which are still free are controlled and checked, for example, by means of the control device 36 or the trace logic circuit 31. The control device 36 or the trace logic circuit 31 thus determines the point in time at which the trace memory 32 will probably be full. In a manner dependent thereon, an occupancy signal that signals that the trace memory is full is output. This occupancy signal can either be signaled by means of a dedicated pin or can be read out cyclically, for example, by means of the external JTAG interface 5, 26. When such an occupancy signal is present, the emulation of the integrated circuit 2 is stopped. This is effected, for example, by interrupting the clock signal for the integrated circuit 2, whereupon the respective states within the integrated circuit 2 are stopped or frozen. As soon as the emulation of the integrated circuit 2 has been stopped, this is signaled to the trace logic circuit 31. Alternatively, the trace logic circuit 31 also detects this itself. The trace memory 32 is consequently enabled for reading. The emulation circuit 3, more precisely the trace memory 32, is then supplied with an externally generated clock signal via the external JTAG interface 5, 26 and the bus master 38, with the result that the trace memory 32 can be read. This read-out operation is carried out until the trace memory 32 is completely empty. In this case, a control signal that signals that the trace memory 32 is now empty is in turn output.

If the read-out operation has been concluded, the integrated circuit 2 is in turn supplied with the externally generated clock signal, so that the emulation can be continued. The emulation then advantageously starts precisely in the state in which it was stopped or frozen for the purpose of reading the trace memory 32.

Although the present invention has been described in more detail above with reference to a preferred exemplary embodiment, it shall not be restricted thereto but rather can be modified in a wide variety of ways.

Thus, the invention shall not necessarily be restricted to the refinement of an integrated circuit in the form of a program-controlled device. Rather, the invention can be used in any desired integrated circuits for the purpose of emulating the latter. However, the invention is particularly advantageous in integrated circuits of very complex design. The invention would also be conceivable for the purpose of emulating very complex circuits which are mapped to FPGAs or PLDs.

Moreover, the invention shall not be restricted to the architecture illustrated in the figure either. Rather, the external connection of the integrated circuit and/or of the emulation circuit and the internal coupling of the two circuit parts can be changed arbitrarily. It goes without saying that, depending on the application, the integrated circuit may also have further internal data and/or address buses and, moreover, further peripheral units and program-controlled devices in addition to the internal bus and the peripheral units.

In the example embodiment above, for the purposes of generalization, a very detailed description of an integrated circuit in the form of a program-controlled device was also dispensed with without, however, restricting the invention thereto.

1. A method for emulating an integrated circuit via an emulation circuit arranged on the same semiconductor chip as the integrated circuit, said emulation circuit having a trace memory and coupled to the integrated circuit to be emulated via an internal interface, said method comprising:
(a) emulating the integrated circuit using the emulation circuit;
(b) continually storing the emulation results obtained during the emulation in the trace memory until the trace memory is full;
(c) interrupting the emulation;
(d) reading out the emulation results from the trace memory; and
(e) continuing the emulation of the integrated circuit by returning to method step (a).

2. A method according to claim 1, wherein only those parts of the emulation circuit and/or of the integrated circuit which, in terms of the emulation, are not required for the state of the emulation circuit and/or of the integrated circuit, are used during method step (d).

3. A method according to claim 2, wherein those parts of the emulation circuit and/or of the integrated circuit which are not required for reading the trace memory are operated, during method step (d), in an operating mode in which their state does not change.

4. A method according to claim 3, wherein the parts of the emulation circuit and/or of the integrated circuit are operated without a clock in the operating mode.

5. A method according to claim 1, further comprising the steps:
fully reading out and storing a state of the integrated circuit in the trace memories;
reading the trace memory; and
writing the state that has been read out back to the integrated circuit.

6. A method according to claim 1, further comprising that shortly before the trace memory is full, an occupancy signal that indicates that the trace memory is full is output, whereupon the emulation is interrupted.

7. A method according to claim 1, wherein in order to set the desired configuration for the emulation, the trace logic of the emulation circuit is preprogrammed before the start of the emulation.

8. A method according to claim 1, wherein a system clock of the integrated circuit is controlled from outside the semiconductor chip.

9. A method according to claim 8, wherein in order to interrupt the emulation, the system clock for the integrated circuit is interrupted, and, in order to read out the emulation data, only the emulation circuit is supplied with a system clock.

10. A method according to claim 1, wherein when the emulation results are read out from the trace memory, the integrated circuit and also the emulation circuit are additionally read, modified and/or configured.

11. A semiconductor chip comprising:
an integrated circuit having an integrated emulation circuit, said emulation circuit comprising a trace logic circuit and a trace memory, said trace logic circuit emulates the integrated circuit, said trace memory stores emulation results ascertained during the emulation of the integrated circuit, wherein the integrated circuit has an internal interface for coupling the emulation to the integrated circuit, and
an external interface to supply the integrated circuit and the emulation circuit with a system clock and via which the trace memory can be read.

12. A semiconductor chip according to claim 11, wherein the external interface is a JTAG interface via which emulation results stored in the emulation circuit can be read out.

13. A semiconductor chip according to claim 11, further comprising a control circuit to supply the integrated circuit and/or the emulation circuit with a system clock in a manner dependent on the configuration set and the current operating mode.

14. A semiconductor chip according to claim 10, further comprising a control circuit to ascertain the occupancy of the trace memory and, in the event a predetermined occupancy of the trace memory is exceeded, initiates reading of the trace memory.

15. A semiconductor chip according to claim 11, wherein the emulation circuit has an output terminal connected to the external interface to signal to the outside that the trace memory is full or will shortly be full.

16. A semiconductor chip according to claim 11, further comprising a scan chain for reading the integrated circuit.

17. A semiconductor chip according to claim 11, wherein the integrated circuit is a microprocessor or a microcontroller.
